(19) United States
(12) Patent Application Publication
(10) Pub. No.: US 2016/0276056 A1
(43) Pub. Date: Sep. 22, 2016

(54) DISPERSIONS FOR NANOPLATELETS OF GRAPHENE-LIKE MATERIALS AND METHODS FOR PREPARING AND USING SAME

(71) Applicant: GRAPHENE 3D LAB INC., Calverton, NY (US)

(72) Inventors: Daniel Stolyarov, Baiting Hollow, NY (US); Elena Polyakova, Baiting Hollow, NY (US); Irina Pomestchenko, Mt. Sinai, NY (US)

(73) Assignee: Graphene 3D Lab Inc., Calverton, NY (US)

(21) Appl. No.: 14/901,032

(22) PCT Filed: Jun. 28, 2014
(86) PCT No.: PCT/US14/44768

§ 371 Date: Dec. 27, 2015

Related U.S. Application Data
(60) Provisional application No. 61/840,464, filed on Jun. 28, 2013.

(51) Int. Cl. H01B 1/24; C08J 3/11; C09D 11/38; B29C 67/00

(52) U.S. Cl. CPC H01B 1/24; B29C 67/0081; B29C 67/0092; C08J 3/11; C09D 11/38; B29K 2105/16

(57) ABSTRACT

A dispersion of nanoplatelet graphene-like material, such as graphene nanoplatelets, in a solid or liquid dispersion media wherein the nanoplatelet graphene-like material is dispersed substantially uniformly in the dispersion media with a graphene-like material dispersant. Such dispersions may be used to prepare articles by three-dimensional (3D) printing, as well as to provide electrically conductive inks and coatings, chemical sensors and biosensors, electrodes, energy storage devices, solar cells, etc. Liquid dispersions may be prepared, for example, by sonication of solutions of graphite flakes, dispersant, and liquid dispersion media, while solid dispersions may be prepared, for example, by combining the melted polymer with the liquid dispersion, dissolving the solid polymer in a miscible solvent and then blending with the liquid dispersion, dissolving the solid polymer in the liquid dispersion, or polymerizing one or more monomers in the liquid dispersion to form the solid polymer.

### CROSS-REFERENCE TO RELATED APPLICATIONS

This application makes reference to and claims the priority benefit of U.S. Provisional Application No. 61/840,464, filed Jun. 28, 2013, entitled “Preparation of Highly Concentrated Dispersions of Graphene and Graphene-Like Materials in Benign Low-Boiling Solvent and Using this Dispersion for Making Functional Coatings,” the entire disclosure and contents of which is hereby incorporated by reference in its entirety.

### FIELD OF THE INVENTION

The present invention relates to dispersions of nanoplatelet graphene-like materials useful, for example, in polymer composites, such as electrically conductive polymer composites, mechanically reinforced composites, composites with improved thermal conductivity, electrically conductive inks and coatings, chemical and bio-sensors, electrodes, energy storage devices, solar cells, etc. The present invention further relates to methods for preparing such dispersions, as well as methods for using such dispersions in a variety of applications, such as conductive coatings for a broad variety of substrates, functional components in polymer composite blends that can be reshaped in the form of filaments or films by extrusion, and may be used for creating electrically conductive articles (e.g., by using three-dimensional (3D) printing, fused deposition modeling (FDM), selective laser sintering (SLS), or inkjet printing techniques), etc.

### BACKGROUND

Graphene is a two-dimensional (2D) atomic crystal comprised of a one-atom thick (i.e., a monolayer) honeycomb arrangement of carbon atoms bonded via sp² bonds, thus forming a thin, nearly transparent sheet. There are multiple techniques for making graphene, and the number of such techniques for making graphene continue to increase as time goes on. For example, graphene formation may be achieved by cleavage of Highly Oriented Pyrolitic Graphite (HOPG) or natural graphite, followed by transfer of a few layers of the cleaved material to a substrate, peeling off surface layers of HOPG or natural graphite using tape, and transferring the peeled surface layers to a substrate by subsequent taping, etc. Graphene may also be formed by an exfoliation and Dry Contact Transfer (DCT) technique, which relies upon transferring small crystallites from a stamp or a mold to a solid substrate.

Graphene may also be formed on metallic substrates by chemical vapor deposition processes, where the metallic substrate may be exposed to the flow of a gaseous mixture, such as methane which contains carbon, at high temperature. This mixture may also include hydrogen a noble gas such as argon. Decomposition of the carbon-containing gas at high temperature catalyzed by metals may also lead to formation of a film, which may comprised of a single or multiple graphene layers. Further, graphene may be produced by epitaxial growth at the surface of a silicon carbide (SiC) crystal.

While graphene may be formed as a one-atom-thick planar sheet comprising a densely packed honeycomb-like crystal lattice, these sheets may also be produced as part of an amalgamation of materials which may include defects in the crystal lattice, such as pentagonal and heptagonal cells (defects), versus regular hexagonal cell arrangement of the crystal lattice. These isolated pentagonal cells present may cause the normally planar graphene sheet to warp into a cone-shaped configuration. Graphene produced by conventional methods may have these or other incorporated defects. These defects in the graphene lattice may be incorporated intentionally by chemical oxidation, exposure to energetic charged particles, such as presenting in plasma, etc. Graphene's properties may also be modified by coating with chemicals, mechanical deformation, etc.

The electronic properties of graphene are also determined by its unique electronic structure. Graphene in its natural state is a semimetal or zero-band gap semiconductor. The band gap of graphene may be manipulated through some structural modifications or by applying external electrical field, such that a wide variety of graphene-based materials possessing either metallic or semiconductor properties may be produced. Graphene exhibits unique properties, including very high strength and robustness, high room temperature electron mobility, optical transparency, impermeability to gases, high thermal conductivity and ability to sustain densities of electric current a million times higher than copper, etc. Graphene also has an exceptionally high specific surface area. The theoretical limit for the specific surface area of graphene is 2630 m²/g. Additionally, because it has no functional groups, graphene may exhibit no/minimal absorption in the mid-infrared (IR) spectral range.

Graphene in the form of nanoscale graphene platelets (NGPs) or graphene nanosheets may provide a useful class of nanomaterials. An NGP is a nanoscale platelet composed of one or more layers of graphene, with a thickness in the range of from about 0.34 to about 100 nm depending upon the number of layers present. In a graphene plane, carbon atoms form a two-dimensional (2D) hexagonal lattice and are bonded together through strong in-plane covalent bonds. In the z-axis or thickness dimension, several graphene layers may be weakly bonded together through van der Waals forces to form a multi-layer NGP. An NGP may be viewed as a flattened sheet of a carbon nanotube (CNT), with a single-layer of NGP (corresponding to a single-wall CNT), while a multi-layer NGP may be viewed as a unrolled multi-wall CNT.

NGPs, being double to multilayer stacked graphene sheets, have also been predicted to and discovered to possess unique physical, chemical, and mechanical properties. Several unique properties associated with these two-dimensional (2D) crystals have been discovered. In addition to single graphene sheets, double layer or multiple-layer graphene sheets may also exhibit unique and useful behaviors. Graphene platelets may be oxidized to various extents during their preparation, resulting in graphite oxide (GO) platelets. Accordingly, although NGPs may include those nanoplatelets containing no or low oxygen content, NGPs may also include GO nanoplatelets of various oxygen contents.

NGPs may be made by exfoliation (e.g., splitting layers) of natural or synthetic graphite, as well as by plasma treatment of synthetic or natural graphite. NGP may also be obtained by the reduction of platelets of graphene oxide either by chemicals such as hydrazine, by high temperature treatment, or by exposure to ultraviolet radiation. These graphene oxide platelets may also be made by chemical oxidation of natural or synthetic graphite (such by the Hummers method or by the modified Hummers method) followed by ultrasonic separation of the graphene oxide particles. Also, NGPs may be made by unzipping of single- or multiwall carbon nanotubes, or by chemical reduction of CO.

### SUMMARY

In a first broad aspect of the present invention, there is provided a composition comprising a dispersion of nanoplatelet graphene-like material, the dispersion comprising:
from about 45 to about 98.9% by weight of the dispersion of a dispersion media;
from about 1 to about 30% by weight of the dispersion of a graphene-like material dispersant which is one or more of: ethyl cellulose; cellulose triacetate; sodium taurodeoxycholate; sodium taurocholate; or trisilanols; and
from about 0.1 to about 50% by weight of the dispersion of a graphene-like material which is substantially uniformly dispersed in the dispersion media and which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe).

In a second broad aspect of the present invention, there is provided a composition comprising a solid polymer dispersion of nanoplatelet graphene-like material, the dispersion comprising:
from about 45 to about 98.8% by weight of the dispersion of a solid polymer dispersion media;
from 1 to about 30% by weight of the dispersion of a graphene-like material dispersant which is one or more of: ethyl cellulose; cellulose triacetate; sodium taurodeoxycholate; sodium taurocholate; or trisilanols; and
from about 0.1 to about 30% by weight of the dispersion of a graphene-like material which is substantially uniformly dispersed in the solid polymer dispersion media and which comprises one or more of: graphene; functionalized graphene; graphene oxide; partially reduced graphene oxide; graphite-flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe); and
from about 0.1 to about 50% by weight of the dispersion of a plasticizer for the solid polymer dispersion media.

In a third broad aspect of the present invention, there is provided a method for preparing a liquid dispersion of nanoplatelet graphene-like material, which comprises the following steps of:
(a) forming a liquid dispersion comprising:
   from about 45 to about 98.9% by weight of the liquid dispersion of a liquid dispersion media;
   from about 1 to about 30% by weight of the liquid dispersion of a graphene-like material dispersant which is one or more of: ethyl cellulose; cellulose triacetate; sodium taurodeoxycholate; sodium taurocholate; or trisilanols; and
   from about 0.1 to about 50% by weight of the liquid dispersion of nanoplatelet graphene-like material; and
(b) agitating the liquid dispersion of step (a) in a manner so as to cause exfoliation and separation of nanoplatelet graphene-like material to form a substantially uniform dispersion of nanoplatelet graphene-like material in the liquid dispersion media;
   the liquid dispersion formed in step (b) comprising:
from about 45 to about 98.9% by weight of the dispersion of the liquid dispersion media;
from about 1 to about 30% by weight of the dispersion of the graphene-like material dispersant; and
from about 0.1 to about 50% by weight of the dispersion of the nanoplatelet graphene-like material.

In a fourth broad aspect of the present invention, there is provided a method for preparing a solid polymer dispersion of nanoplatelet graphene-like material, which comprises the following steps of:
(a) forming a liquid dispersion comprising:
   from about 60 to about 98.9% by weight of the liquid dispersion of a liquid dispersion media;
   from about 1 to about 30% by weight of the liquid dispersion of a graphene-like material dispersant which is one or more of: ethyl cellulose; cellulose triacetate; sodium taurodeoxycholate; sodium taurocholate; or trisilanols; and
   from about 0.1 to about 30% by weight of the liquid dispersion of nanoplatelet graphene-like material which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe); and
(b) combining the liquid dispersion of step (a) with a solid polymer in a manner which causes the nanoplatelet graphene-like material to be substantially uniformly dispersed in the solid polymer to thereby form a solid polymer dispersion;
   the solid polymer dispersion formed in step (b) comprising:
from about 60 to about 98.9% by weight of the solid polymer dispersion of the solid polymer;
from about 1 to about 30% by weight of the solid polymer dispersion of the graphene-like material dispersant; and
from about 0.1 to about 30% by weight of the solid polymer dispersion of the nanoplatelet graphene-like material.

In a fifth broad aspect of the present invention, there is provided a method for preparing an article comprising a solid polymer having nanoplatelet graphene-like material substantially uniformly dispersed therein, which comprises the following steps of:
(a) providing a solid polymer dispersion having a substantially uniform dispersion of nanoplatelet graphene-like material and comprising:
   from about 45 to about 98.9% by weight of the solid polymer dispersion of one or more thermoplastic polymers;
   from about 1 to about 30% by weight of the solid polymer dispersion of a graphene-like material dispersant which is one or more of: ethyl cellulose; cellulose triacetate; sodium taurodeoxycholate; sodium taurocholate; or trisilanols; and
   from about 0.1 to about 30% by weight of the solid polymer dispersion of nanoplatelet graphene-like material and which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe); and from about 0.1 to about 50% by weight of the solid polymer dispersion of a plasticizer for the solid polymer dispersion media; and
(b) by using a three-dimensional (3D) printing technique, a fused deposition modeling (FDM) technique, or a selective laser sintering (SLS), forming the solid polymer dispersion of step (a) into an article comprising nanoplatelet graphene-like material substantially uniformly dispersed in a solid polymer.

### BRIEF DESCRIPTION OF THE DRAWINGS

The invention will be described in conjunction with the accompanying drawings, in which:

FIG. 1 is a Raman spectrum of a conductive film formed by coating a paper support with the nanoplatelet graphene dispersion; and

FIG. 2 is an image of a scanning electron micrograph (SEM, 1300× magnification) of image of the sample whose Raman spectrum is shown in FIG. 1.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

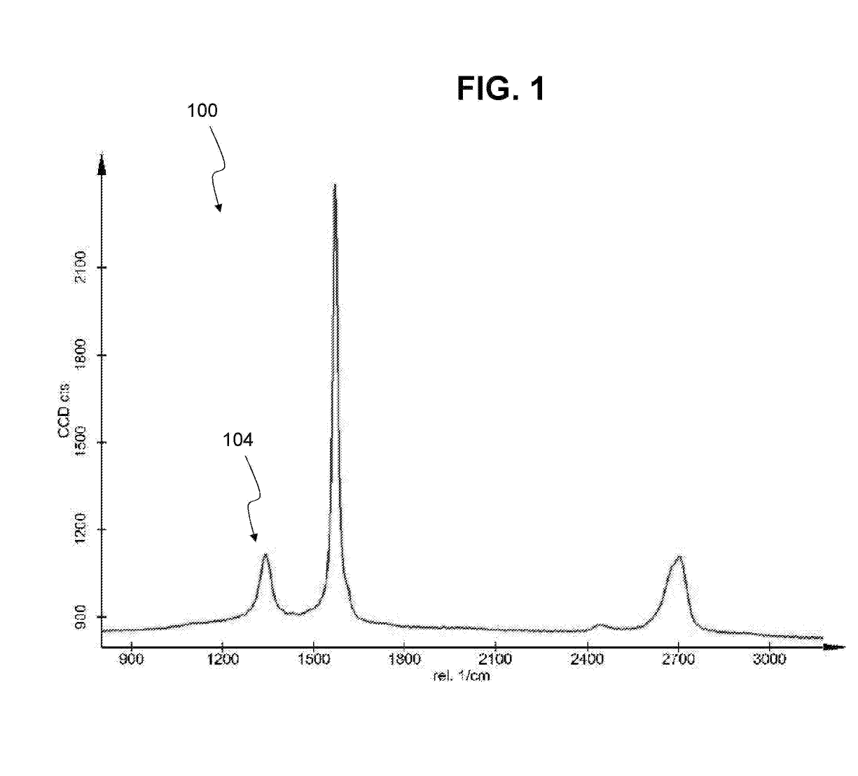

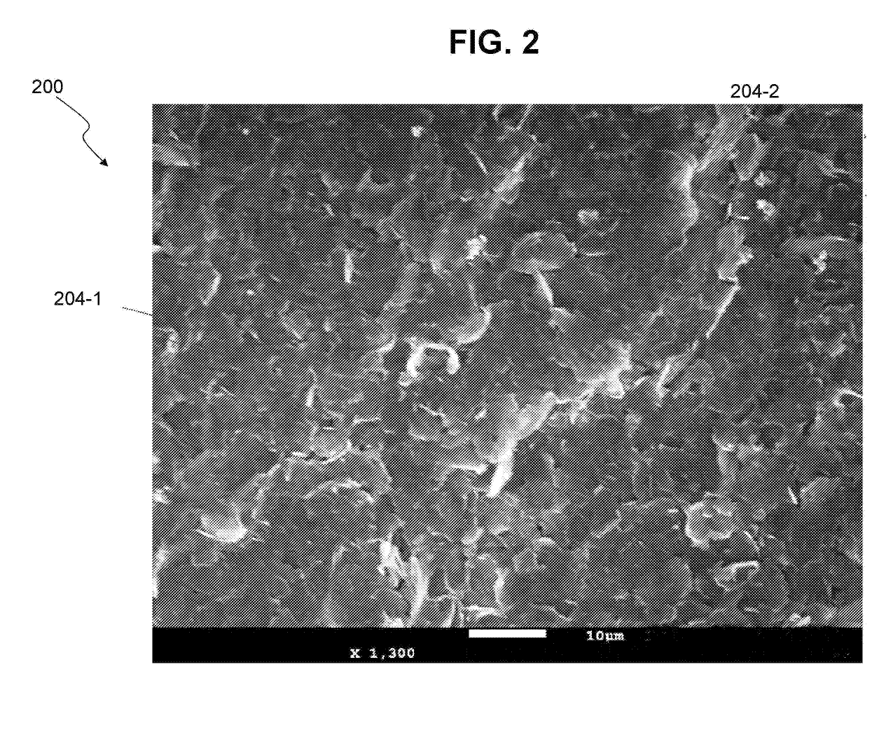

For the purposes of the present invention, directional terms such as “outer,” “inner,” “upper,” “lower,” “top,” “bottom,” “side,” “front,” “frontal,” “forward,” “rear,” “rearward,” “back,” “trailing,” “above,” “below,” “left,” “right,” “horizontal,” “vertical,” “upward,” “downward,” etc. are merely used for convenience in describing the various embodiments of the present invention. For example, the embodiments of the present invention illustrated in FIGS. 1 and 2 may be oriented in various ways.

For the purposes of the present invention, the term “electrically conductive materials” refers to a material which has the property, capability, etc., to conduct an electric current. Electrically conductive materials may include conductive materials (e.g., metals such as copper), semiconductor materials, as well as combinations thereof.

For the purposes of the present invention, the term “graphene-like material” refers to a material, substance, etc., which may have a layered structure the same or similar to graphene. Graphene-like materials may include one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Se₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); cadmium selenide (CdSe); etc.

For the purposes of the present invention, the term “nanoscopic” refers to materials, substances, structures, etc., having a size in at least one dimension (e.g., thickness) of from about 1 to about 1000 nanometers, such as from about 1 to about 100 nanometers. Nanoscopic materials, substances, structures, etc., may include, for example, nanoplatelets, nanotubes, nanowhiskers, etc.

For the purposes of the present invention, the term “quantum dot” refers to a nanocrystal made from graphene or graphene-like materials which are small enough to exhibit quantum mechanical properties.

For the purposes of the present invention, the term “graphene” refers to pure or relatively pure carbon in the form of a relatively thin, nearly transparent sheet, which is one atom in thickness (i.e., a monolayer sheet of carbon), or comprising multiple layers (multilayer carbon sheets), having a plurality of interconnected hexagonal cells of carbon atoms which form a honeycomb like crystalline lattice structure. In addition to hexagonal cells, pentagonal and heptagonal cells (defects), versus hexagonal cells, may also be present in this crystal lattice.

For the purposes of the present invention, the term “functionalized graphene” refers to graphene which has incorporated into the graphene lattice a variety chemical functional groups such as —OH, —COOH, NH₂, etc., in order to modify the properties of graphene.

For the purposes of the present invention, the term “graphene oxide” (also known as “graphitic acid” and “graphite oxide”) refers interchangeably to a compound of carbon, oxygen, and hydrogen which may exist in variable ratios of these three atoms, and which may be obtained by treating graphite with strong oxidizers.

For the purposes of the present invention, the term “partially reduced graphene oxide” refers to graphene oxide that, upon reduction, contains from about 5 about 30% oxygen by weight of the graphene oxide.

For the purposes of the present invention, the term “dispersion” refers to a two (or more)-phase system which may be for, example, in the form of an suspension, colloid, solution, etc., in which solid materials (e.g., particles, powders, etc.) comprising the internal (dispersed) phase are dispersed, suspended, etc., in the external or continuous (bulk) phase (e.g., a solvent, suspending medium, colloidal medium, etc.).

For the purposes of the present invention, the term “dispersion media” refers to a composition, compound, substance, etc., which provides the external or continuous (bulk) phase of the dispersion. Dispersion media may be a liquids, solids, etc. Liquid dispersion media may be solvents, mixtures of solvents, any other substance, composition, compound, etc., which exhibits liquid properties at room or elevated temperatures, etc. Solid dispersion media may be one or more of: polymers (e.g., a solid or melted polymer/polymer melt); glasses; metals; metal oxides; etc. Suitable polymers for use as solid dispersion media or as melted polymer/polymer melts may include, for example, one or more of: acrylate or methylmethacrylate polymers or copolymers, such as polyacrylates, polymethylmethacrylates, etc.; polylactic acid (PLA) polymers; polyhydroxyalkanoate (PHA) polymers, such as polyhydroxybutyrate (PHB); polycaprolactone (PCL) polymers; polyglycolic acid polymers; acrylonitrile-butadiene-styrene polymers (ABS); polyvinylidene fluoride polymers, polyurethane polymers, polyolefin polymers (e.g., polyethylene, polypropylene, etc.), polyester polymers, polyamide polymers, etc.

For the purposes of the present invention, the terms “graphene-like material dispersant,” “graphene-like material dispersing aid” and “graphene-like material dispersing agent” refer interchangeably to a composition, compound, substance, etc., (e.g., a surfactant) which promotes the dispersion, suspension, separation, etc., of solid graphene-like materials in the internal (disperse) phase of the dispersion and throughout the external or continuous (bulk) phase of the dispersion. Suitable dispersants for nanoplatelets of graphene-like materials for use herein may include, for example, one or more of: ethyl cellulose; cellulose triacetate; sodium taurodeoxycholate; sodium taurocholate; or trisilanols (e.g., POSS® trisilanols (polyhedral organomeric silsesquinoxane).

For the purposes of the present invention, the term “solution” refers to a homogeneous or a relatively homogeneous mixture comprising only one phase wherein the solid material (the solute) is dissolved in another substance (the solvent).

For the purposes of the present invention, the term “fillers” refers to additives which may alter a composite's mechanical properties, physical properties, chemical properties, etc, and which may include, for example, one or more of: magnesium oxide, hydrous magnesium silicate, aluminum oxides, silicon oxides, titanium oxides, calcium carbonate, clay, chalk, boron nitride, limestone, diatomaceous earth, mica, glass quartz, ceramic and/or glass microbeads, metal or metal oxide fibers and particles, Magnetite®, magnetic Iron(III) oxide, carbon nanotubes and/or fibers, etc.

For the purposes of the present invention, “plasticizer” refers to the conventional meaning of this term as an agent which, for example, softens, makes more flexible, malleable, pliable, plastic, etc., a polymer, thus providing flexibility, pliability, durability, etc., which may also decrease the melting and the glass transition temperature of the polymer, and which may include, for example, one or more of: tributyl citrate, acetyl tributyl citrate, diethyl phthalate, glycerol triacetate, glycerol tripropionate, triethyl citrate, acetyl triethyl citrate, phosphate esters (e.g., triphenyl phosphate, resorcinol bis(diphenyl phosphate), olicomeric phosphate, etc.), long chain fatty acid esters, aromatic sulfonamides, hydrocarbon processing oil, propylene glycol, epoxy-functionalized propylene glycol, polyethylene glycol, polypropylene glycol, partial fatty acid ester (Loxiol GMS 95), glucose monoester (Dehydrat VPA 1726), epoxidized soybean oil, acetylated coconut oil, linseed oil, epoxidized linseed oil, etc.

For the purposes of the present invention, the term “impact modifiers” refers to additives which may increase a composite's resistance against breaking under impact conditions, and which may include, for example, one or more of: polymers or copolymers of an olefin, for example, ethylene, propylene, or a combination of ethylene and propylene, with various (meth)acrylate monomers and/or various maleic-based monomers; copolymers derived from ethylene, propylene, or mixtures of ethylene and propylene, as the alkylene component, butyl acrylate, hexyl acrylate, propyl acrylate, a corresponding alkyl(methyl)acrylates or a combination of the foregoing acrylates, for the alkyl(meth)acrylate monomer component, with acrylic acid, maleic anhydride, glycidyl methacrylate or a combination thereof as monomers providing an additional moieties (i.e., carboxylic acid, anhydride, epoxy); block copolymers, for example, A-B diblock copolymers and A-B-A triblock copolymers having of one or two aryl alkylene blocks A, which may be polystyrene blocks, and a rubber block, B, which may be derived from isoprene, butadiene or isoprene and butadiene; etc.

For the purposes of the present invention, the term “flame retardant” refers to a composition, compound, substance, etc., which makes the treated material therewith resistant to fire, flame, burning, etc.

For the purposes of the present invention, the term “stabilizers” refers to thermal, oxidative, and/or light stabilizers. Thermal stabilizers refer to additives to a composite which improves the composite's resistance to heat, resulting in sustaining composite's properties at higher temperatures compared to materials without the stabilizer and may include, for example, one or more of: a hydrogen chloride scavenger such as epoxidized soybean oil, etc. Oxidative stabilizers refer to additives to a composite which improve the composite's resistance to oxidative damage (including alteration of any properties) which may result from, but not limited to oxidation by atmospheric air, corrosive or other reactive chemicals (e.g., acids, peroxides, hypochlorides, ozone, etc.), and may include, for example, one or more of: alkoxy substituted (e.g., propoxy) hindered amine light stabilizers (NOR HALS), N-(1,3-dimethylbutyl)-N′-phenyl-p-phenylenediamine (6PPP), N-isopropyl-N-phenyl-p-phenylenediamine (IPPD), 6-ethoxy-2,2,4-trimethyl-1,2-dihydroquinoline (ETMQ), ethylene diurea (EDU), paraffin waxes, etc. Light stabilizers refer to additives which may improve the composite's resistance to damage (including alteration of any properties) resulting from the exposure to natural or artificial light in a wide spectral range (from deep UV to mid IR), and may include, for example, one or more of: ultra violet (UV) light stabilizers, hindered amine light stabilizers (HALS), (HAS), etc.

For the purposes of the present invention, the term “colorants” refers to compositions, compounds, substances, materials, etc., such as pigments, tints, etc., which causes a change in color of a substance, material, etc.

For the purposes of the present invention, the term “thermal conductivity” refers to the property, capability, capacity, etc., of a material, substance, etc., to conduct heat.

For the purposes of the present invention, the terms “graphene platelets” and “graphene sheets” refer interchangeably to platelets of graphene comprising one or more layers of a two-dimensional (2D) graphene plane, and may also refer to platelets and sheets comprised of graphene oxide, partially reduced graphene oxide, functionalized graphene, etc.

For the purposes of the present invention, the term “graphene nanoplatelets (NGPs)” and “nanosheets” refer interchangeably to platelets of graphene, and may also refer to platelets and sheets comprised of graphene oxide, partially reduced graphene oxide, functionalized graphene, etc., having a thickness in the range of from about 0.34 to about 100 nm.

For the purposes of the present invention, the term “graphene-like nanoplatelets” refers to graphene-like materials having platelet characteristics the same or similar to graphene nanoplatelets (NGPs).

For the purposes of the present invention, the term “flakes” refers to particles in which two of the dimensions (i.e., width and length) are significantly greater compared to the third dimension (i.e., thickness).

For the purposes of the present invention, the term “graphite flakes” refers to graphite material in the form of flakes.

For the purposes of the present invention, the term “closely-spaced stack-like arrangement” refers to an atomic arrangement in a crystalline phase wherein covalently or ionically bonded atoms form layered structures, which arrange themselves in close proximity and parallel to each other. These layers are weakly bound by Van der Waals forces

For the purposes of the present invention, the term “substrate” refers to a base component of a composite and wherein other components may be blended with it, placed on its surface, etc.

For the purposes of the present invention, the term “powder” refers to a solid material which is comprise of a large number of fine particles.

For the purposes of the present invention, the term “film” refers to a relatively thin continuous layer of material, and which may be supported on or by other materials, or which may be unsupported on or by other materials.

For the purposes of the present invention, the term “solvent” refers to a liquid which may dissolve or suspend another material which may be a solid, gas, or liquid.

For the purposes of the present invention, the term “compatible solvent” refers to a solvent which may provide an effective medium for the formation of a solution or dispersion of one or more solutes without significant detrimental effects to the other components present in the solution or dispersion, e.g., is miscible.

For the purposes of the present invention, the term “low boiling solvent” refers to a solvent which boils at or near a temperature of about 100° C. or less. Suitable low boiling solvents for use herein may include, for example, one or more of: isopropanol (isopropyl alcohol); ethyl acetate; tetrahydrofuran (THF); acetonitrile; chloroform; dichloromethane; acetone; etc.

For the purposes of the present invention, the term “high boiling solvent” refers to refers to a solvent which boils at or near a temperature of greater than about 100° C. Suitable high boiling solvents for use herein may include, for example, one or more of: dimethylformamide, N-dodecyl-pyrrolidone, N-formyl-piperidine, dimethylacetamide, dimethyl-imidazdinone N-methyl-pyrrolidone, N-octylpyrrolidone, N-ethyl-pyrrolidone, 3-(2-oxo-1-pyrolidinyl) propanenitrile, N-benzyl-pyrrolidone, N-butylpyrrolidone, dimethyl-tetrahydro-2-pyrimidinone, cyclohexyl-pyrrolidone, and N-vinyl pyrrolidone; etc.

For the purposes of the present invention, the term “inorganic precursors” refers to one or more inorganic compounds which may be used as starting materials in preparing of intermediates, as well as finished products, compositions, compounds, etc.

For the purposes of the present invention, the term “blend,” “blending,” and similar words and/or phrases refers to combining, mixing together, unifying, etc., a plurality of components, compounds, compositions, substances, materials, etc.

For the purposes of the present invention, the term “substantially uniform” refers to a dispersion, material, substance, etc., which is substantially uniform in terms of composition, texture, characteristics, properties, etc.

For the purposes of the present invention, the term “low viscosity” refers to a material, liquid, melt, etc. which flows freely when poured, spread, mixed, etc.

For the purposes of the present invention, the term “composite” refers to multicomponent material wherein each component has, imparts, etc., a distinct function, property, etc., to the multicomponent material.

For the purposes of the present invention, the term “hybrid composite” refers to a composite comprising two or more components, constituents, etc., dispersed at the nanometer or molecular level in any solid or liquid media.

For the purposes of the present invention, the term “in situ” refers to the conventional chemical sense of a reaction that occurs “in place” in the reaction mixture.

For the purposes of the present invention, the term “exfoliation” refers to the chemical and/or physical process of separation of layers of a material (e.g., graphite flakes).

For the purposes of the present invention, the term “intercalation” refers to the to the process of insertion of atoms or molecules in between layers of layered structures. Intercalation may be a part of the exfoliation process.

For the purposes of the present invention, the term “percolation” refers to the process of formation of a continuous three-dimensional (3D) network.

For the purposes of the present invention, the term “ultrasonic” refers to a sound wave frequency, as well as waves generated at that frequency, devices generating such a wave frequency, etc., which is about 20 kHz or greater.

For the purposes of the present invention, the term “cavitation” refers to the formation of vapor (gaseous) cavities in a liquid.

For the purposes of the present invention, the term “sonication” refers to applying sound energy (e.g., sound waves) to agitate, stir, mix, etc., for example, one or more liquids, solid particles, etc. Sonication may also be used to facilitate the process of exfoliation.

For the purposes of the present invention, the term “chemical vapor deposition” refers to a chemical process used to produce high-purity, high-performance solid materials, such as exposing a substrate material to one or more volatile precursors, which react and/or decompose on the substrate surface to produce the desired deposited material.

For the purposes of the present invention, the term “chemical oxidation” refers to oxidation achieved by a chemical process, reaction, etc.

For the purposes of the present invention, the term “electrochemical oxidation” refers to oxidation achieved by an electrochemical process, reaction, etc.

For the purposes of the present invention, the term “thin film deposition” refers to the technique of applying (depositing) a thin film to or on the surface of a substrate, material, etc.

For the purposes of the present invention, the term “inert atmosphere” refers to a gaseous atmosphere (e.g., argon, nitrogen, helium, etc.) which is chemically relatively nonreactive.

For the purposes of the present invention, the term “reducing atmosphere” refers to a gaseous atmosphere (e.g., hydrogen, etc.) which may cause the chemical reduction of a substance, substrate, compound, etc., under ambient, as well as elevated temperatures and pressures.

For the purposes of the present invention, the term “single batch reaction” refers to a process in which the reactor is reloaded, resupplied, etc., with reactants after the completion of each reaction cycle that results in product(s).

For the purposes of the present invention, the term “continuous batch reaction” refers to a process in which a continuous flow of reagents may be supplied to the reactor and in which a continuous flow of resulting product(s) may be collected from the reactor during the course of the reaction.

For the purposes of the present invention, the term “solid” refers to refers to non-volatile, non-liquid components, compounds, materials, etc.

For the purposes of the present invention, the term “liquid” refers to a non-gaseous fluid components, compounds, materials, etc., which may be readily flowable at the temperature of use (e.g., room temperature) with little or no tendency to disperse and with a relatively high compressibility.

For the purposes of the present invention, the term “room temperature” refers to refers to the commonly accepted meaning of room temperature, i.e., an ambient temperature of from about 20° to about 25° C.

For the purposes of the present invention, the term “thermoplastic” refers to the conventional meaning of thermoplastic, i.e., a composition, compound, material, etc., that exhibits the property of a material, such as a high polymer, that softens or melts so as to become pliable when exposed to sufficient heat and generally returns to its original condition when cooled to room temperature.

For the purposes of the present invention, the term “thermoset” refers to the conventional meaning of thermoset i.e., a composition, compound, material, etc., that exhibits the property of a material, such as a polymer, resin, etc., that irreversibly cures such that it does not soften or melt when exposed to heat.

For the purposes of the present invention, the term “printed electronic circuitry” refers to electronic circuitry created by various printing methods or techniques such as, for example, flexography, gravure printing, offset lithography, inkjet printing, etc.

For the purposes of the present invention, the term “flexible circuits” (also known as “flex circuits,” flexible PCBs, “flexi-circuits,” etc.) refers to circuits formed from a thin insulating polymer film having conductive circuit patterns affixed thereto and which may be supplied with a thin polymer coating to protect the conductor circuits formed.

For the purposes of the present invention, the term “membrane switches” refers to electrical switch where the circuit printed on a polymer such as polyethylene terephthalate (PET) or on a metal oxide such indium tin oxide (ITO).

For the purposes of the present invention, the term “thin film batteries” refers to a battery formed from materials, some of which may be, for example, only nanometers or micrometers thick, thus allowing the finished battery to be only millimeters thick.

For the purposes of the present invention, the term “key pad” refers to a set of alphanumeric buttons, keys, etc., which bear digits, symbols, letters, etc., as well as combinations thereof and which may provide an input interface between a user and an electronic system (e.g., a computer, entry lock, etc.).

For the purposes of the present invention, the term “heat sink refers to a passive heat exchanger which cools a device by dissipating heat into the surrounding medium and which may be capable of efficient transfer and dissipation of heat produced by other components (e.g., electronic, etc.).

For the purposes of the present invention, the term “roll to roll thick film printing” refers to a process of applying coatings, printing, etc., as well as performing other processes which start with a roll of a flexible material and which then reel up that material after the process, operation, etc., is completed to create, provide, etc., an output roll.

For the purposes of the present invention, the term “3D current conductors” refers to three-dimensional (3D) structures designed to conduct electrical current.

For the purposes of the present invention, the term “solar cell grid collectors” refers to the part of the solar cell, such as is made of metal or other conductive material, and which collects charges generated in/by semiconductor part of a solar cell.

For the purposes of the present invention, the term “lightening surge protectors” refers to a device connected upstream from an electrically powered appliance and which mitigates, moderates, lessens, etc., any perturbations of the supply line characteristics (e.g., overvoltage) due to, for example, a lightening event.

For the purposes of the present invention, the term “electromagnetic interference (EMI) shielding” refers to shielding against electromagnetic disturbances, such as radiofrequency interference.

For the purposes of the present invention, the term “flexible displays” refers to a display capable of being deformed, (e.g., by bending) and which is beyond the pliability of other conventional displays.

For the purposes of the present invention, the term “photovoltaic devices” refers to devices such as solar panels, solar cells, etc., which generate electrical power by converting solar radiation into direct current electricity.

For the purposes of the present invention, the term “smart labels” refers to radiofrequency identification (RFID) labels which, for example, may be embedded as inlays inside label material, and then, for example, printing bar code and/or other visible information on the surface of the label.

For the purposes of the present invention, the term “radio-frequency identification (RFID) tags” refers to tags attached to objects that contain electronically stored information, and which, through use of radiofrequency electromagnetic fields, permit automatic identifying and tracking of such tags.

For the purposes of the present invention, the term “three-dimensional (3D) printing” (also known as “additive printing” and “additive manufacturing”) refers to any of various processes (e.g., coating, spraying, depositing, applying, etc.) for making a three-dimensional (3D) object from a three-dimensional (3D) model, other electronic data source, etc., through additive processes in which successive layers of material may be laid down, for example, under computer control.

For the purposes of the present invention, the term “comprising” means various compounds, components, ingredients, substances, materials, layers, steps, etc., may be conjointly employed in embodiments of the present invention. Accordingly, the term “comprising” encompasses the more restrictive terms “consisting essentially of” and “consisting of.”

For the purposes of the present invention, the terms “a” and “an” and similar phrases are to be interpreted as “at least one” and “one or more.” References to “an” embodiment in this disclosure are not necessarily to the same embodiment.

For the purposes of the present invention, the term “and/or” means that one or more of the various compositions, compounds, ingredients, components, elements, capabilities, steps, etc., may be employed in embodiments of the present invention.

For the purposes of the present invention, the term “module” refers to an isolatable element that performs a defined function and has a defined interface to other elements. These modules may be implemented in hardware, a combination of hardware and software, firmware, wetware (i.e., hardware with a biological element) or a combination thereof, all of which are considered to be functionally (e.g., behaviorally) equivalent.

### DESCRIPTION

Graphene materials feature many properties, such as exceptional mechanical strength, high electrical conductivity, etc., which make may make it a material of choice for a significant number of commercial applications. For example, due to graphene's very high carrier (electron and hole) mobility on the order of 200,000 cm²/V, graphene may find use in many modern high-speed and low energy consumption electronic devices. Additionally, because it has no functional groups, graphene may exhibit no/minimal absorption in the mid-infrared (IR) spectral range.

Graphene-based nanolayers, such as nanoscale graphene platelets (NGPs), graphene-based nanotubes, etc., may also offer various uses within commercial electronics. For example, graphene-based nanotube switching devices may be used as nonvolatile memory devices, combined to form logic gates, used to form analog circuit elements such as nanotube-based field effect transistors and programmable power supplies, etc. In particular, two terminal nanotube based switching devices may be used within electronic systems, such as memory arrays, microprocessors, and field programmable gate arrays (FPGAs), etc. Also, NGPs and platelets of graphene may be used for making electrodes of batteries, supercapacitors and other electrochemical devices, as additive to composite materials such as NGP-filled epoxy resin.

Graphene in the form of nanoplatelet graphene dispersions may be used to provide, for example, polymeric composites, electrically conductive inks and coatings, chemical sensors and biosensors, electrodes and energy storage devices, such as solar cells, etc. These graphene dispersions may be applied, for example, as a highly-conductive thin film to a variety of substrates for these applications. Such films may be obtained, for example, by various deposition techniques, such as manual smearing, spin-coating, spray deposition ink jet printing, etc. If used to form a polymer composite, nanoplatelet graphene dispersions may be deposited provide conductive layers or structures, either in supported or unsupported matrices, by, for example, three-dimensional (3D) printing techniques, including, but not limited to fused deposition modeling (FDM), stereo lithography (STL), etc.

Graphene's properties may also be enhanced by the use of additional components, including plasticizers, fillers, impact modifiers, etc. These additional components may improve the mechanical, physical, chemical and other properties of the graphene dispersion, as well as enhancing the electrical and thermal conductivity of graphene for selected applications.

The electrical and thermal conductivities of nanoplatelet graphene material dispersions may be highly dependent of the load graphene materials in the dispersion media. Higher loadings of such materials may consequently result in the higher thermal and electric conductivity. Even so, preparing a highly loaded and/or homogeneous dispersions of nanoplatelet graphene materials may be a challenge. There are two factors contributing to this challenge: (1) the tendency of nanoscale dispersants to aggregate; and (2) the hydrophobic nature of the surface of some nanoplatelet materials, such as nanoplatelet graphene, used in the embodiments of present invention. Such hydrophobicity can be alleviated by the treatment of graphene nanoplatelets or graphite by the Hummers method, for making graphene oxide, but which requires the use of harsh chemical oxidants of graphite such as potassium permanganate (KMnO₄), concentrated sulfuric acid (H₂SO₄) and nitric acid (HNO₃), and then subsequent reduction of the oxidation product. In spite of the advantages gained by improved dispersibility of graphene oxide (compared to graphene nanoplatelets and graphite) in water and many organic solvents, such graphene oxide materials may effectively become electrical insulators due to the disruption of its sp² bonding network because of the presence of oxygen functionalities on the surface of the graphene oxide moieties. The recovery of the hexagonal network and electrical conductivity of such graphene oxide materials (to a degree) may be achieved by reduction of the graphene oxide. But as more oxygen groups are removed, the resulting graphene oxide becomes more difficult to disperse due to its tendency to create aggregates. Another method for creating graphene dispersions uses surfactants, such as sodium dodecylbenzene sulfonate and sodium dodecyl sulfate, etc., but which also coat graphene flakes, thus forming an insulating layer on the surface of those flakes, and consequently compromising the electrical and thermal conductivity of resulting dispersions.

By contrast, embodiments of the present invention avoid such shortcomings, and thus result in the formation of highly conductive dispersions by usage of certain dispersants (e.g., ethyl cellulose, cellulose triacetate, etc.) to form more highly-concentrated (i.e., up to about 30% to about 50% by weight) dispersion of graphene flakes when starting from, for example, graphite or pre-processed graphene nanoplatelets. These nanoplatelet graphene dispersions may be prepared by combining, for example, graphene nanoplatelets with these certain dispersant in one or more dispersion media with subsequent use of, for example, ultrasonic probe processing to achieve stable and substantially uniform (homogeneous) dispersions. A unique combination of a dispersion media (e.g., solvent or a solid polymer), certain dispersants, and a mixture of nanoplatelet graphene materials (and additionally one or more plasticizers when the dispersion media comprises a solid polymer) may be used to make stable nanoplatelet graphene (and other nanoplatelet graphene-like materials) dispersions which may be used to coat various surfaces such as glass, paper, plastic, silicone, etc., to form conductive films without the need for high temperature treatment, thus permitting more volatile (i.e., low-boiling point) dispersion media be used to make air-drying at ambient temperatures sufficient for a film formation. Furthermore, these nanoplatelet graphene dispersions may be combined with other materials to make composites, such as polymer composites.

Adding even small amounts of nanoscale graphene platelets (NGPs) or other graphene-like platelets to solid polymers (as the solid dispersion media for the NGPs) may modify the properties of those polymers in a variety of desirable ways. Compared to the original polymer, the resulting nanocomposite may be mechanically stronger, while also exhibiting electrical and thermal conductivity. The uniform distribution of these graphene nanoplatelets in the solid polymer may also be important for modifying the properties of the polymer material. The uniform distribution of such nanoplatelet graphene (or other nanoplatelet graphene-like materials) in the polymer matrix may be difficult to achieve because the particles of nanoplatelet material may tend to conglomerate. Even so, embodiments of the nanoplatelet graphene (and other nanoplatelet graphene-like materials) solid polymer dispersions of the present invention enable these nanoplatelet materials to be uniformly dispersed in the solid polymer matrix.

The Raman spectrum (measured in units of charged coupled device counts (CCD) along the Y-axis versus reciprocal centimeters (l/cm) along X-axis) of one such conductive film formed by coating a paper support with a nanoplatelet graphene dispersion is shown in FIG. 1 and is indicated generally as 100. As shown by spectrum 100, and as indicated by arrow 104, there is a lower intensity D-line, located at 1350 l/cm, in spectrum 100 which signifies the low level of lattice defects. FIG. 2 represents an scanning electron microscope (SEM) image, indicated generally as 200, of the nanoplatelet graphene dispersion sample whose Raman spectrum is shown in FIG. 1. FIG. 2 shows percollating graphene nanoplatelets, two of which are indicated by arrows 204-1 and 204-2, and which provide enhanced electrical conductivity.

Embodiments of the dispersions of nanoplatelet graphene-like materials of the present invention may comprise: from about 45 to about 98.9% (such as from about 60 to about 80%) by weight of the dispersion of a dispersion media; from about 1 to about 30% (such as from about 5 to about 20%) by weight of the dispersion of certain dispersants; and from about 0.1 to about 50% (such as from about 10 to about 25%) by weight of the dispersion of nanoplatelet graphene or certain other nanoplatelet graphene-like materials which is substantially uniformly dispersed in the dispersion media. For solid polymer dispersions, the dispersion may additionally comprise from about 0.1 to about 50% (such as from about 5 to about 25%) by weight of the dispersion of a plasticizer for the solid polymer dispersion media.

Embodiments of the method of the present invention for preparing a liquid dispersion of nanoplatelet graphene-like material may comprise step (a) of forming a liquid dispersion comprising: from about 45 to about 98.9% (such as from about 60 to about 80%) by weight of the liquid dispersion of a liquid dispersion media; from about 1 to about 30% (such as from about 5 to about 20%) by weight of the liquid dispersion of certain of graphene dispersants; and from about 1 to about 50% (such as from about 5 to about 30%) by weight of the liquid dispersion of nanoplatelet graphene-like material. In step (b), the liquid dispersion of step (a) is agitated in a manner so as to cause exfoliation and separation of nanoplatelet graphene-like material to form a substantially uniform dispersion of nanoplatelet graphene in the liquid dispersion media. (Other layered graphene-like materials, for example, h-BN and metal chalcogenides, such as MoS₂ may be obtained in the form of nanoplatelets by exfoliation and separation from the bulk crystals).

Embodiments of the method of the present invention for preparing a solid polymer dispersion of nanoplatelet graphene-like material may comprise step (a) of forming a liquid dispersion comprising: from about 45 to about 98.9% (such as from about 70 to about 85%) by weight of the liquid dispersion of a liquid dispersion media; from about 1 to about 30% (such as from about 1 to about 10%) by weight of the liquid dispersion of certain of graphene dispersants; and from about 0.1 to about 30% (such as from about 5 to about 20%) by weight of the liquid dispersion of nanoplatelet graphene-like material. In step (b), the liquid dispersion of step (a) is combined with a solid polymer in a manner which causes the nanoplatelet graphene-like material to be substantially uniformly dispersed in the solid polymer to thereby form a solid polymer dispersion. In some embodiments, step (b) may be carried out, for example, by: (1) melting the solid polymer and blending the liquid dispersion of step (a) with the melted polymer; (2) dissolving the solid polymer in a miscible solvent and then blending the miscible solvent containing the dissolved polymer with the liquid dispersion of step (a); (3) dissolving the solid polymer in the liquid dispersion of step (a); (4) polymerizing one or more monomers in the liquid dispersion of step (a) to form the solid polymer; etc. These solid polymer dispersions of nanoplatelet graphene-like material may be further pelletized, crushed, milled, extruded in the form of filaments, powders, pellets, or films and further processed/deposited, for example, by 3D printing techniques, to form 3-dimentional objects, as described hereafter.

Embodiments of the method of the present invention for preparing an article comprising a solid polymer having nanoplatelet graphene-like material substantially uniformly dispersed therein may comprise step (a) of providing a solid polymer dispersion having a substantially uniform dispersion of nanoplatelet graphene-like material and comprising: from about 60 to about 98.9% (such as from about 70 to about 85%) by weight of the solid polymer dispersion of one or more thermoplastic polymers; from about 1 to about 30% (such as from about 1 to about 10%) by weight of the solid polymer dispersion of certain of graphene dispersants; and from about 0.1 to about 30% (such as from about 10 to about 25%) by weight of the solid polymer dispersion of nanoplatelet graphene-like material; and from about 0.1 to about 50% (such as from about 5 to about 25%) by weight of the dispersion of a plasticizer for the solid polymer dispersion media. In step (b), the solid polymer dispersion of step (a), by using a three-dimensional (3D) printing technique, a fused deposition modeling (FDM) technique, or a selective laser sintering (SLS), may form an article comprising nanoplatelet graphene-like material substantially uniformly dispersed in a solid polymer.

In providing dispersions in some embodiments of the present invention, butyl acetate may be employed as the solvent. The exfoliation of the graphene layers from, for example, graphite may be assisted by an environmentally benign, naturally occurring, dispersant such as ethyl cellulose. The dispersant is unique in that it transforms a non-ideal solvent for graphite exfoliation into one that enables very high carbon (graphene) loadings without incurring an exponential increase in viscosity. This characteristic enables multiple uses such as: filling ink-jet printer cartridges; creating conducting pastes wherein up to about 50% of the material is solid carbon (graphene), etc. For example, one such embodiment may comprise about 2% by weight of the ethyl cellulose in the butyl acetate with subsequent incorporation of nanoplatelet graphene-like materials in an amount of about 50% by weight of the resulting mixture, followed by the use an ultrasonic agitation for from about 30 from about 60 minutes to create a homogeneous, substantially liquid dispersion of thereof.

Examples of other low boiling solvents which may be used in preparing such liquid dispersions may include, for example, one or more of: isopropanol, ethyl acetate, tetrahydrofuran (THF), acetonitrile, chloroform, dichloromethane, etc. The latter two solvents (chloroform and dichloromethane) may be useful if a non-flammable solvent is desired or the dispersant is cellulose triacetate (due to its better solubility in halogenated (e.g., chlorinated) solvents, as well as usefulness when heat and shrink resistance along with shape stability may be needed). High boiling solvents useful formulating such liquid dispersions may be from the amide family such as, for example dimethylformamide, as well as other high boiling solvents such as N-dodecyl-pyrrolidone, N-formyl-piperidine, dimethylacetamide, dimethyl-imidazdinone, N-methyl-pyrrolidone, N-octylpyrrolidone, N-ethyl-pyrrolidone, 3-(2-oxo-1-pyrolidinyl) propanenitrile, N-benzyl-pyrrolidone, N-butylpyrrolidone, dimethyl-tetrahydro-2-pyrimidinone, cyclohexyl-pyrrolidone, N-vinyl pyrrolidone, etc.

In an embodiment of one method, nanoplatelet graphene graphene-like materials) may be dispersed in a polymer melt at elevated temperatures which may also be assisted by the addition of a compatible solvent. This method may be carried out either by heating the polymer beyond its melting point with subsequent admixing of the compatible solvent already containing previously dispersed nanoplatelet graphene-like materials nanoplatelets, or alternatively by adding nanoplatelets graphene-like materials) nanoplatelets directly to the melted polymer-solvent blend. One embodiment of this method may use a dilute solution (e.g., about 2% by weight) of a modified biopolymer, ethyl cellulose, as a graphene dispersant, 15% by weight polymer dissolved in a compatible solvent, and 15% by weight tributyl citrate as the plasticizer. In addition to an already formed polymer, one embodiment of the present invention may utilize in-situ polymerization of low viscosity monomers/precursors. As an example, and without limitation, the amount of ethyl cellulose solution may be reduced by 75% and then adding to the remainder of the ethyl cellulose solution low viscosity acrylate monomers. The blend comprising the nanoplatelet graphene-like materials) may then be dispersed with the monomers acting as a solvent. After dispersion, a free radical initiator (e.g., azobisisobutyronitrile, di-tert-butyl peroxide, peroxydisulfates, etc.) may be added to the mixture by using mechanical stirring. Subsequently, a thick film coating may be drawn out onto a glass slide and heated to decompose the free radical initiator. The acrylate monomers may then be polymerized to form a hard, conductive polyacrylate composite wherein the conductive nanoplatelet carbon (graphene) element may be locked into the composite matrix.

In another embodiment, partially reduced graphene oxide may be blended with, for example, low viscosity hexamethylene diisocyanate, a building block of polyurethane. The isocyanate group may then be reacted with the alcohol group of the reduced graphene oxide (which may also function to keep the resulting dispersion homogeneous), thereby forming a covalent C—O bond via the urethane linkage. Afterward, a low viscosity polyether polyol (e.g., polyethylene glycol, polypropylene glycol, poly(tetramethylene ether, etc.) of about 70 cps which is flowable and may be added to react with the remaining isocyanate groups to form the polyurethane-graphene complex.

In another embodiment, the amount of ethyl cellulose in the solution may be reduced by about 75% with the remaining solution further comprising, for example, a blend of N-vinyl pyrrolidone and low viscosity acrylate monomers. This mixture may be subsequently polymerized by a heat activated free radical mechanism (which involves thermal decomposition of an initiator to form free radicals which subsequently react with the monomer and start a free radical chain reaction, thus ultimately leading to the formation of polymer chains) to form a hybrid polyvinylpyrrolidone/polyacrylate/nanoplatelet graphene-like material composite.

In one embodiment of the present invention, any class of polymer (e.g., vinyl polymers, silicone polymers, olefin polymers, polyesters, phenolic resins, etc.) may be synthesized in-situ in combination with nanoplatelet graphene-like materials and the ethyl cellulose graphene-like material dispersant. The only requirement in this embodiment is that the monomers used be of a low enough viscosity (i.e., liquid and/or gaseous) to enable intimate mixing of the monomer(s) and other components of the final composite (e.g., nanoplatelet graphene-like material, as well as metal additives, organic additives, etc.). Even polyethylene composites comprising nanoplatelet graphene-like material may be made by polymerization of ethylene gas, or may be synthesized using short chain alpha olefins, for example, carbon chain lengths which are longer than n-pentene, such as n-octene. Exemplary embodiments may be a n-octene hybrid polyvinylpyrrolidone/polyacrylate/nanoplatelet graphene-like material composites, PLA polymer/nanoplatelet graphene-like material composites, PCL polymer/nanoplatelet graphene-like material composites, etc.

In another embodiment, nanoplatelet graphene-like material materials may be uniformly dispersed in a polymer melt or solution of polymers (for example, such as ABS polymers, PLA polymers, PCL polymers, etc.) in any compatible solvent (such as chloroform, dichloromethane, etc.) along with a plasticizer (such as tributyl citrate, etc.) and dispersant (such as ethyl cellulose, etc.) as needed. Upon agitation and solvent removal, the resulting solid polymer nanocomposite comprising the nanoplatelet graphene-like materials may be extruded in the form of a filaments, powders, or films and then pelletized (i.e., formed into pellets), crushed, milled, etc., if necessary, and may be further processed to create 3D architectures by variety of 3D printing techniques.

In another embodiment, polyvinylidene fluoride polymers (e.g., sold under the tradenames Kynar by Arema or Hylar by Solvay) which show piezoelectric properties and become ferroelectric when poled (i.e., when placed under a strong electric field to induce a net dipole moment) may be used in combination with these nanoplatelet graphene-like material dispersions. Polyvinylidene fluoride polymers are used extensively in battery and sensor applications. However, the monomer vinylidene fluoride may also exist as a gas. Thus, higher molecular weight oligomers of vinylidene fluoride may be used in embodiments of this method.

In some embodiments of the present invention, sonication or other methods for exfoliating flakes may be used. In one such embodiment, the physical exfoliation of flake graphite into monolayer or few layers of graphene platelets may be accomplished by agitation such as, for example, by ultrasonically generated cavitation bubbles produced, for example, by lower power sonication baths or high power ultrasound cell disruptors. These dispersions containing graphite flakes and other additives (e.g., surfactants) may be subjected to ultrasound waves and the resulting particles separated based on their size (e.g., by centrifugation). The exfoliation overcomes the van der Waals forces holding the two-dimensional planes of graphite or other layered materials in a closely-spaced stack-like arrangement. The apparatus, such as high intensity ultrasonic processor, needed for making nanoplatelet graphene-like material flakes by means of exfoliation and separation of graphite (or other nanoplatelet graphene-like materials) in a liquid may be one capable of creating the shearing forces to generate the cavitation bubbles, as described above.

In various embodiments of the present invention, these nanoplatelet graphene-like material dispersions may be blended using other suitable processing techniques such as mixing, dispersing, etc., using compounding techniques and apparatus for blending, etc. Ultrasonic devices, cryogenic grinding crushers, kneaders, extruders, high pressure homogenizers, attrition equipment, ball mills, high-shear mixers, two or three-roll mills, etc., may be suitable techniques and apparatus for these embodiments.

In some embodiments of the present invention, different graphene materials may be used. In one such embodiment, graphene sheets may be isolated from graphite, expandable graphite, expanded graphite, etc., using a range of suitable methods. These methods may include, for example: physical exfoliation of graphite, by for example, peeling, grinding, milling off, etc., graphene sheets; using inorganic precursors, such as silicon carbide; chemical vapor deposition using gaseous, liquid or solid carbon sources, with and without metal catalyst (e.g., with or without nickel, copper, etc.); or by the reduction of an alcohol, such ethanol, with a metal (e.g., an alkali metal such as sodium, potassium, etc.) and subsequent pyrolysis. Graphene sheets may also be made from graphite oxide ((GO), also known as graphitic acid or graphene oxide) by sonication of GO in various solvents to produce GO dispersions followed by partial chemical or electrochemical reduction to graphene. These graphene sheets may be functionalized with oxygen-containing functional groups (including hydroxyl groups, carboxyl groups, and epoxy groups, etc.), for example, by treating graphite with strong oxidants such as potassium chlorate, sulfuric acid, perchloric acid, nitric acid, potassium permanganate, etc. In one embodiment, graphite flakes may be treated using electrochemical or chemical oxidation, which may then be ultrasonically exfoliated and reduced to graphene sheets. In one embodiment, graphene sheets may be also formed by mechanical treatment (such as grinding, milling, etc.) to exfoliate graphite oxide, which may then be subsequently reduced to graphene sheets.

In some embodiments, the nanoplatelet graphene-like materials may comprise multiple components, such as two or more powders, particulates, flakes, etc., each having different particle size distributions and/or morphologies (e.g., nanoplatelets, nanowires, fullerenes, etc.). Mixing together two different types of graphene-like material nanoplatelets may also greatly improve the stability of the dispersion.

In some embodiments of the present invention, layered graphene-like materials similar to graphite flakes other than graphene may be used for which exfoliation methods may be applicable. These other layered graphene-like materials may include one or more of: molybdenum disulfide (MoS₂), molybdenum diselenide (MoSe₂), molybdenum ditelluride (MoTe₂), tungsten disulfide (WS₂), tungsten diselenide (WSe₂), hexagonal boron nitride (h-BN), gallium sulfide (GaS), gallium selenide (GaSe), lanthanum cuprate (La₂CuO₄), bismuth tritelluride (Bi₂Te₃), antimony triselenide (Sb₂Se₃), bismuth triselenide (Bi₂Se₃), zinc oxide (ZnO), niobium disulfide (NbS₂), niobium diselenide (NbSe₂), titanium disulfide (TaS₂), vanadium disulfide (VS₂), rhenium disulfide (ReS₂), rhenium diselenide (ReSe₂), titanium disulfide (TiS₂), titanium diselenide (TiSe₂), indium trisulfide (In₂S₃), zirconium disulfide (ZrS₂), zirconium diselenide (ZrSe₂), cadmium selenide (CdSe), etc., as well as any combination of these materials, including with nanoplatelet graphene-like materials.

In one embodiment, metal particles or wires (such as metal nanoparticles, metal nanowires, etc.) may be added to this dispersion, thereby imbuing thick films with 3-dimensional (3D) electrical and thermal conductivity.

In one embodiment, dispersions may also be comprised of electrically conductive additives, such as metals, polymers, conductive metal oxides, metal-coated materials, and other carbonaceous materials, and may take the form of particles, powders, foils, flakes, rods, fibers, etc.

In one embodiment, metals may be used as additives and may include, for example, one or more of: aluminum, palladium, platinum, nickel, copper, silver, gold, bronze, or chromium, as well as metal oxides which may include, for example, indium tin oxide, antimony tin oxide, and other fillers coated with metal oxides, etc.

In other embodiments, nanoplatelet graphene-like-containing materials may be coated, such as by using chemical vapor deposition, with the metals and metal-oxides described above, and may include, for example, carbon and graphite fibers, ceramics, glass fibers, etc.

In one embodiment, the additives may also include quantum dots.

Embodiments of the present invention may provide improved conductivity after thin film deposition of these nanoplatelet graphene-like material dispersions. In one embodiment, nanoplatelet graphene-like material dispersions may be applied to substrates such as glass, plastic, fabric, paper, cartons, etc., to name a few.

In one embodiment, nanoplatelet graphene-like material dispersions may be applied as patterns, letters, logos, or any other shapes which may be imaged, and may be covered by additional materials such as varnishes, fabrics, polymers, etc.

In another embodiment, while thin films made from such nanoplatelet graphene-like material dispersions may be conductive, heating up to 370° C. may improve the conductivity of these films by factor of 2-4. These films may be heated in an inert or reducing atmosphere, or under vacuum conditions using a fused silica, ceramic, or metallic vessel. When heating such materials using furnaces, infrared heaters, or other suitable means, they may be contained in a single batch reaction vessel, or a continuous batch reaction may be used to move the materials through vessels that use furnaces and infrared heaters.

In one embodiment, these films may then be applied to a substrate and cured using a range of techniques. These techniques may include, but are not limited to, for example, one or more of: drying and oven-drying, thermal curing, IR curing, drying, crosslinking, laser curing, microwave curing, sintering, etc.

In one embodiment, polymerizable additives (e.g., additives capable of forming polymeric structures, such as from monomers and/or oligomers, etc.) may also be mixed in by sonication in the same vessel, and may serve to increase conductivity and promote adhesion of the nanoplatelet graphene-like material dispersion to a plurality of substrates. Acrylate monomers may be used to crosslink and further stabilize the dispersion, as well as to enable good adhesion of a modified biopolymer/nanoplatelet graphene-like material composite to the substrate.

In one embodiment, melt processing (e.g., by physical or chemical manipulations of the polymer in its melted state) and dispersion blending (e.g., by mixing carried out in the dispersion) may be used to combine graphene-like material dispersions with polymers. In case of dispersion blending, this processing may be achieved, for example, by preparing the solution of the dispersant in the compatible solvent with the subsequent introduction of the desired amount of nanoplatelet graphene-like materials, and the combining of the resulting mixture to the polymer solution containing plasticizer. Upon addition/mixing of the components, ultrasonic agitation may be used to achieve a substantially uniform dispersion. For example, when the melt processing route is being executed, the dispersant and plasticizer may be introduced into the melted polymer or blend of melted polymers with the subsequent gradual introduction of the nanoplatelet graphene-like material. Thorough mixing may be required for homogeneity of the resulting nanocomposite to be usable. Exemplary polymers which may be processed by this approach may include thermoplastics, thermosets, non-melt processable polymers, or monomers which may be polymerized before, during, or after these polymers are applied to the substrate.

In one embodiment, a solution of ethyl cellulose in butyl acetate may be used as such a dispersant to create liquid dispersions of nanoplatelet graphene-like materials.

In one embodiment, a blend of carbon allotropes (e.g., single or multilayer nanoplatelet graphene, nanoplatelet partially reduced graphene oxide, nanoplatelet functionalized graphene, etc., single or multiwall carbon nanotubes, fullerenes, graphite, etc.) may be used to optimize conductivity, morphology, stability, etc.

In one embodiment, acrylate monomers may be used to crosslink and further stabilize the dispersion, as well as to enable good adhesion of a modified biopolymer/nanoplatelet graphene-like material composite to the substrate.

Examples of uses for these dispersions of nanoplatelet graphene-like materials may include, for example, but are not limited to: printed electronic circuitry, flexible circuits, membrane switches, keypads, improved electrodes for rechargeable lithium-ion batteries, thin film batteries, heat sinks for semiconductor laser diodes, roll to roll thick film printing of 3D current conductors, reduction or total replacement of metals in 3D composites such as lightweight, high strength aircraft parts, and catalyst supports.

Examples of commercial applications of these dispersions of nanoplatelet graphene-like materials may include, for example: as an additive to tires, solar cell grid collectors, lightning surge, protection, electromagnetic interference shielding (EMI shielding), electromagnetic radiation shields, electrostatic shields, flexible displays, photovoltaic devices, smart labels, myriad electronic devices (music players, games, calculators, cellular phones), decorative and animated posters, active clothing, RFID tags, etc.

Embodiments of these dispersions of nanoplatelet graphene-like materials may also be used as an additive to plastic materials, including UV-resistant plastics, sensors (such as gas sensors or biosensors,), for labels and in packaging for inventory control, advertising, and information gathering, etc. These dispersion compositions may further comprise additional components and additives, including, but not limited to: reinforcing agents; fillers; plasticizers; impact modifiers; flame retardants; lubricants; thermal, oxidative, and/or light stabilizers; mold release agents; colorants; etc.

The advantages and benefits of the embodiments of these dispersions of nanoplatelet graphene-like materials of the present invention may include a reduction in cost. As the price for silver and copper rise, OEM manufacturers may seek a competitive advantage by reducing the high cost of electronic circuitry. Energy storage (such as batteries and supercapacitors) companies may need better carbonaceous materials to improve both the energy and power density of their commercial products. Upon recharge, nanosilicon anodes used in lithium-ion batteries expand 400%. Since silicon anodes may be brittle, repeated expansion and contraction greatly decreases the number of cycles of the electrode. Using nanoplatelet graphene-like material-based electrodes accommodates this expansion, greatly improving the cycle lifetime of silicon anodes. Improved 3D conductivity: nanoplatelet graphene-like materials combined with carbon black may improve cathode capacity and enable faster transport of lithium ions to the active cathode material. The three dimensional conductivity imparted by the carbon fiber may also find utility in thick film coatings. nanoplatelet graphene-like material composites may have a lower viscosity than other carbon pastes currently in use, and an aerosol process such as an air brush may be used to apply these highly conductive coatings, thereby improving throughput during manufacturing.

The advantages and benefits of the embodiments of these dispersions of nanoplatelet graphene-like materials of the present invention may include room temperature processing. While heating may improve the conductivity of the nanoplatelet graphene-like material dispersions, room processed films may also be useful in myriad applications. For example, nanoplatelet graphene-like material dispersions may expand the selection of target substrates when compared to, for example, Cu and Ag inks.

The advantages and benefits of the embodiments of these dispersions of nanoplatelet graphene-like materials of the present invention may include improved stability. While copper inks tend to oxidize, these carbon dispersions and thin films are inert.

The advantages and benefits of the embodiments of these dispersions of nanoplatelet graphene-like materials of the present invention may include improved thermal management. Embodiments of such highly concentrated nanoplatelet graphene-like material dispersions prepared by the methods described herein may be used in preparation of thermal heat sink compounds either by itself or in combination with a matrix. The coatings formed by these nanoplatelet graphene-like material dispersions may be expected to have high thermal conductivity.

The advantages and benefits of the embodiments of these dispersions of nanoplatelet graphene-like materials of the present invention may include reduced weight. The composite materials prepared by adding these highly concentrated nanoplatelet graphene-like material dispersions may be expected to have outstanding mechanical properties and be easily machinable. These materials may be suitable for manufacturing aircraft parts, where the mechanical strength may be accompanied by a decrease in weight.

The advantages and benefits of the embodiments of these dispersions of nanoplatelet graphene-like materials of the present invention may include the use of composites for preparing various articles by three-dimensional (3D) printing techniques. These highly concentrated dispersions of the graphene platelets described herein, may be used as additives to polymers used in 3D printing to improve the mechanical stability and/or electrical and thermal conductivity of the article (e.g., a part of article, a component of article, a finished article, etc.) manufactured by such 3D printing. Manufacturing of a functional device may require using of a variety of functional materials such as insulators, electric conductors, magnetic materials, etc. Materials used by conventional manufacturing methods such as metals, plastics, ceramics, etc., may be required to be processed under very different conditions, thus, making it difficult to use these materials within a single 3D printing process. The embodiments of the present invention may help to avoid such problems by adding nanoplatelets graphene-like materials to the polymer to give the resulting dispersion the required functional properties while maintaining properties important for processing of the original polymer. For example adding some amount of nanoplatelet graphene-like materials to PLA polymers by embodiments of methods described herein, may make resulting dispersion capable of conducting electrical current, while maintaining the melting temperature of the resulting dispersion as close to the melting temperature of the original polymer, thus making possible the use both polymer dispersion and original polymer during a single 3D printing process for manufacturing a functional device comprising of insulating and electrically conductive parts, whereas PLA polymers may be used for making insulating parts and the nanoplatelet graphene-like material dispersions may be used for making electrically conductive parts.

Embodiments of materials of the present invention (e.g., articles comprising polymer composites containing nanoplatelets graphene-like materials) may be suitable, for example, for creating “printed conductive circuitry” that may, for example, be deposited, or may be “printed’ using a variety of modern techniques, such as 3D printing, inkjet printing, selective laser sintering (SLS), fused deposition modeling (FDM) and other methods. For example, coomplete conductive circuits/pathways may be imbedded into insulating frame or casing and may be printed in one continuous process, easing dramatically the production and assembly of the final product. These printed conductive pathways may be used to create integrated electrical circuitry (e.g., as printed circuit boards), heat sinks, ion batteries, (super)capacitors, antennae (e.g., RFID tags), electromagnetic interference shielding, electromagnetic radiation shields, solar cell grid collectors, electrostatic shields, or any other application where conductors of electrical current are used. The ability of functional nanoplatelet graphene-like materials to be printed together with other components of the final product makes their use advantageous compared to other methods (e.g., lithography etc.) due to: higher throughput since all materials may be printed on the same equipment (e.g., printer); better compatibility between components since all materials are polymer based; ability to create complex three-dimensional (3D) structures; ability to seamlessly integrate conductive circuits into the bulk of the final product; simultaneous incorporation of components with single or multiple functionalities; ease of production, since all components may be produced in one process without or minimum post-printing treatment, etc.

Other examples of nanoplatelet graphene-like material dispersion prepared by embodiments of the methods described herein and which may be used as functional material for 3D printing may include: dispersions of magnetic nanoparticles as a magnetic material; dispersions of graphene or BN nanoplatelets or blends thereof as the material with improved thermal conductivity; dispersions of NGPs as a mechanically reinforced material; dispersions of quantum dots as a fluorescent material; etc.

Some examples of printing conductive polymer composites comprising nanoplatelet graphene-like materials using different printing methods may include, for example:

Fused Deposition Modeling (FDM) and Three-Dimensional (3D) Printing.

Both methods are additive manufacturing (AM) techniques and may be based on the extrusion of polymer-based filament (at temperatures around its melting point transition) through a nozzle onto a supporting substrate. The precisely controlled (computer controlled) motion of the nozzle on 3-axes allows polymer deposition in three dimensions. FDM differs from 3D printing in using a supportive polymer structure, which may be removed after the model is complete, while 3D printing methods may not have to use such supports. The polymer nanocomposites may be produced, described in embodiments of the present invention which may be conductive, magnetic, reinforced, etc., in the form of filaments to fit currently available 3D/FDM printers with their compositions altered to allow extrusion of these filaments at conditions used in those printers (e.g., by using plasticizers and other additives). The conductive nanocomposites, for example, may be co-printed together with non-conductive plastics using multi-nozzle printers, building an entire product in one continuous process using a single computer model.

Selective Laser Sintering (SLS).

SLS is another additive manufacturing method and similar to 3D printing which enables the production of complex 3D structures using polymer precursors. The polymer precursor may be used in the form of a powdered material which may be heated in the focal point of a laser source, resulting in the local melting and sintering polymer particles together. The movement of the laser focal point in the XY plane, together with the movement of the base containing the precursor in Z direction, may result in the formation of a 3D object. Composites containing nanoplatelet graphene-like materials which may be suitable for an SLS process, and exhibiting different properties such as conductivity, magneticity, structural stability etc., may be produced, for example, by using polymer/oligomer blends containing nanoplatelet graphene-like materials dispersions. The properties of these composites may be optimized for use in an SLS process by using other additives, such as plasticizers, etc.

Inkjet Printing.

In inkjet printing, the material may be deposited through the expulsion of a liquid solution from a container under high pressure in the form of small droplets into and onto substrate. Once on the substrate, the solvent may be quickly dried leaving the nanoplatelet graphene-containing material adhered to the surface. Alternatively, the use of solvent may be avoided by using photo-curable materials such as inks, which are liquid in the initial form and which may be printed into or onto the substrate using conventional jet printing methods. Once on the surface, these curable inks may be exposed to light (such as UV light), resulting in the formation of a nanoplatelet graphene-like material-containing polymer film. These nanoplatelet graphene-like material-containing polymer composites may be prepared in the form of an ink suitable for inkjet printing by using, for example, quick drying solvents (e.g., ketones, chlorinated hydrocarbons, etc.), etc. For example, the use of ethyl cellulose as a dispersant may enable a very high carbon loading (in the case of nanoplatelet graphene) without a significant increase in viscosity, which may be desirable for creating highly conductive and printable inks. These nanoplatelet graphene-like material-containing dispersions may be also introduced into monomer or oligomer blends containing photoinitiators, electroinitiators, or thermal initiators, thus resulting in a conductive curable nanoplatelet graphene-like material-containing ink.

This application may incorporate material which is subject to copyright protection. The copyright owner has no objection to the facsimile reproduction by anyone of this application or any portion of this disclosure, as it appears in the Patent and Trademark Office patent/patent application file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the scope of the present invention should not be limited by any of the above described exemplary embodiments.

In addition, it should also be understood that any figures in the drawings that highlight any functionality and/or advantages, are presented herein for illustrative purposes only. The disclosed architecture is sufficiently flexible and configurable, such that it may be utilized in ways other than those that may be shown. For example, the steps listed in any flowchart may be re-ordered or only optionally used in some embodiments.

Further, the purpose of the Abstract of the Disclosure in this application is to enable the U.S. Patent and Trademark Office, as well as the public generally, including any scientists, engineers and practitioners in the art who are not familiar with patent or other legal terms or phraseology, to determine quickly from a cursory inspection the nature and essence of the technical disclosure of the application. Accordingly, while the Abstract of the Disclosure may be used to provide enablement for the following claims, it is not intended to be limiting as to the scope of those claims in any way.

Finally, it is the applicants' intent that only claims that include the express language “means for” or “step for” be interpreted under 35 U.S.C. §112, paragraph 6. Claims that do not expressly include the phrase “means for” or “step for” are not to be interpreted as being within the purview of 35 U.S.C. §112, paragraph 6.

1. A composition comprising a dispersion of nanoplatelet graphene-like material, the dispersion comprising:
from about 45 to about 98.9% by weight of the dispersion of a dispersion media;
from about 1 to about 30% by weight of the dispersion of a graphene-like material dispersant which is one or more of: ethyl cellulose; cellulose triacetate; sodium taurodeoxycholate; sodium taurocholate; or trisilanols; and
from about 0.1 to about 50% by weight of the dispersion of a graphene-like material which is substantially uniformly dispersed in the liquid media and which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe).

2. The composition of claim 1, wherein the nanoplatelet graphene or graphene-like material comprises one or more of graphene; functionalized graphene; graphene oxide; or partially reduced graphene oxide.

3. The composition of claim 2, wherein the nanoplatelet graphene-like material comprises graphene nanoplatelets.

4. The composition of claim 1, wherein the dispersion media is a solid dispersion media.

5. The composition of claim 4, wherein the solid dispersion media comprises one or more polymers, and wherein the nanoplatelet graphene-like material is substantially uniformly dispersed in the polymers.

6. The composition of claim 1, wherein the dispersion media is a liquid dispersion media.

7. The composition of claim 6, wherein the liquid dispersion media comprises a low boiling solvent.

8. The composition of claim 7, wherein the low boiling solvent comprises one or more of: butyl acetate; isopropanol; ethyl acetate; tetrahydrofuran (THF); acetonitrile; chloroform; dichloromethane; or acetone.

9. The composition of claim 6, wherein the liquid dispersion media comprises a high boiling solvent.

10. The composition of claim 9, wherein the high boiling solvent comprises one or more of: dimethylformamide; N-dodecyl-pyrrolidone; N-formyl-piperidine; dimethylacetamide; dimethyl-imidazdinone; N-methyl-pyrrolidone; N-octylpyrrolidone; N-ethyl-pyrrolidone; 3-(2-oxo-1-pyrolidinyl) propanenitrile; N-benzyl-pyrrolidone; N-butylpyrrolidone; dimethyl-tetrahydro-2-pyrimidinone; cyclohexyl-pyrrolidone; or N-vinyl pyrrolidone.

11. The composition of claim 1 wherein the dispersion comprises:
from about 60 to about 80% by weight of the dispersion of a dispersion media;
from about 5 to about 20% by weight of the dispersion of the graphene-like material dispersant; and
from about 10 to about 25% by weight of the dispersion of the nanoplatelet graphene-like material.

12. The composition of claim 1, wherein the graphene-like material dispersant comprises ethyl cellulose.

13. A composition comprising a solid polymer dispersion of nanoplatelet graphene-like material, the dispersion comprising:
from about 45 to about 98.9% by weight of the dispersion of a solid polymer dispersion media;
from about 1 to about 30% by weight of the dispersion of a graphene-like material dispersant which is one or more of: ethyl cellulose; cellulose triacetate; sodium taurodeoxycholate; sodium taurocholate; or trisilanols; and
from about 0.1 to about 30% by weight of the dispersion of nanoplatelet graphene-like material which is substantially uniformly dispersed in the solid polymer dispersion media and which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe); and
from about 0.1 to about 50% by weight of the dispersion of a plasticizer for the solid polymer dispersion media.

14. The composition of claim 13, wherein the plasticizer comprises one or more of: tributyl citrate; acetyl tributyl citrate; diethyl phthalate; glycerol triacetate; glycerol tripropionate; triethyl citrate; acetyl triethyl citrate; triphenyl phosphate; resorcinol bis(diphenyl phosphate); olicomeric phosphate; long chain fatty acid esters; aromatic sulfonamides; hydrocarbon processing oil; propylene glycol; epoxy-functionalized propylene glycol; polyethylene glycol; polypropylene glycol; partial fatty acid ester; glucose monoester; epoxidized soybean oil; acetylated coconut oil; linseed oil; or epoxidized linseed oil.

15. The composition of claim 13, wherein the solid polymer dispersion media comprises one or more of: acrylate polymers; methyl methacrylate polymers; acrylate and methacrylate copolymers; polylactic acid (PLA) polymers; polyhydroxyalkanoate (PHA) polymers; polycaprolactone (PCL) polymers; polyglycolic acid polymers; acrylonitrile-butadiene-styrene (ABS) polymers; polyvinylidene fluoride polymers; polyurethane polymers; polyolefin polymers; polyester polymers; or polyamide polymers.

16. The composition of claim 13, wherein the solid polymer dispersion is in the form of filaments, powders, or pellets.

17. A method for preparing a liquid dispersion of nanoplatelet graphene-like material, which comprises the following steps of:
(a) forming a liquid dispersion comprising:
from about 45 to about 98.9% by weight of the liquid dispersion of a liquid dispersion media;
from about 1 to about 30% by weight of the liquid dispersion of a graphene-like material dispersant which is one or more of: ethyl cellulose; cellulose triacetate; sodium taurodeoxycholate; sodium taurocholate; or trisilanols; and
from about 1 to about 50% by weight of the liquid dispersion of nanoplatelet graphene-like material; and
(b) agitating the liquid dispersion of step (a) in a manner so as to cause exfoliation and separation of nanoplatelet graphene-like material to form a substantially uniform dispersion of nanoplatelet graphene-like material in the liquid dispersion media;
the liquid dispersion formed in step (b) comprising:
from about 45 to about 98.9% by weight of the dispersion of the liquid dispersion media;
from about 1 to about 30% by weight of the dispersion of the graphene-like material dispersant; and
from about 0.1 to about 50% by weight of the dispersion of the nanoplatelet graphene-like material.

18. The method of claim 17, wherein step (b) is carried out by sonication of the liquid dispersion of step (a).

19. The method of claim 18, wherein the sonication of step (b) is carried out by generating ultrasonically cavitation bubbles in the liquid dispersion of step (a).

20. The method of claim 17, wherein the liquid dispersion of step (a) comprises a low boiling solvent and wherein the low boiling solvent comprises one or more of: butyl acetate; isopropanol; ethyl acetate; tetrahydrofuran (THF); acetonitrile; chloroform; dichloromethane; or acetone.

21. The method of claim 17, wherein the liquid dispersion of step (a) comprises:
from about 60 to about 80% by weight of the liquid dispersion of the liquid dispersion media;
from about 5 to about 20% by weight of the liquid dispersion of ethyl cellulose; and
from about 5 to about 30% by weight of the liquid dispersion of graphite flakes.

22. The method of claim 17, wherein the the liquid dispersion formed in step (b) is used to carry out inkjet printing.

23. A method for preparing a solid polymer dispersion of nanoplatelet graphene-like material, which comprises the following steps of:
(a) forming a liquid dispersion comprising:
from about 60 to about 98.9% by weight of the liquid dispersion of a liquid dispersion media;
from about 1 to about 30% by weight of the liquid dispersion of a graphene-like material dispersant which is one or more of: ethyl cellulose; cellulose triacetate; sodium taurodeoxycholate; sodium taurocholate; or trisilanols; and
from about 0.1 to about 30% by weight of the liquid dispersion of nanoplatelet graphene-like material which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe); and
(b) combining the liquid dispersion of step (a) with a solid polymer in a manner which causes the nanoplatelet graphene-like material to be substantially uniformly dispersed in the solid polymer to thereby form a solid polymer dispersions;
the solid polymer dispersion formed in step (b) comprising:
from about 60 to about 98.9% by weight of the solid polymer dispersion of the solid polymer;
from about 1 to about 30% by weight of the solid polymer dispersion of the graphene-like material dispersant; and
from about 0.1 to about 30% by weight of the solid polymer dispersion of the nanoplatelet graphene-like material.

24. The method of claim 23, wherein step (b) is carried out by melting the solid polymer and blending the liquid dispersion of step (a) with the melted polymer.

25. The method of claim 23, wherein step (b) is carried out by dissolving the solid polymer in a miscible solvent and then blending the miscible solvent containing the dissolved polymer with the liquid dispersion of step (a).

26. The method of claim 23, wherein step (b) is carried out by dissolving the solid polymer in the liquid dispersion of step (a).

27. The method of claim 23, wherein step (b) is carried by polymerizing one or more monomers in the liquid dispersion of step (a) to form the solid polymer.

28. The method of claim 23, wherein the solid polymer of step (a) comprises one or more of: acrylate polymers; methyl methacrylate polymers; acrylate and methacrylate copolymers; polylactic acid (PLA) polymers; polyhydroxyalkanoate (PHA) polymers; polycaprolactone (PCL) polymers; polyglycolic acid polymers; acrylonitrile-butadiene-styrene (ABS) polymers; polyvinylidene fluoride polymers; polyurethane polymers; polyolefin polymers; polyester polymers; or polyamide polymers.

29. The method of claim 23, wherein the graphene-like material dispersant of step (a) comprises ethyl cellulose.

30. The method of claim 23, wherein the solid polymer dispersion formed in step (b) further comprises from about 5 to about 25% by weight plasticizer.

31. A method for preparing an article comprising a solid polymer having nanoplatelet graphene-like material substantially uniformly dispersed therein, which comprises the following steps of:
(a) providing a solid polymer dispersion having a substantially uniform dispersion of nanoplatelet graphene-like material and comprising:
from about 45 to about 98.9% by weight of the solid polymer dispersion of one or more thermoplastic polymers;
from about 1 to about 30% by weight of the solid polymer dispersion of a graphene dispersant which is one or more of: ethyl cellulose; cellulose triacetate; sodium taurodeoxycholate; sodium taurocholate; or trisilanols; and
from about 0.1 to about 30% by weight of the solid polymer dispersion of nanoplatelet graphene-like material and which comprises one or more of: graphene; functionalized graphene; graphene oxide; partially reduced graphene oxide; graphite flakes; molybdenum disulfide (MoS₂); molybdenum diselenide (MoSe₂); molybdenum ditelluride (MoTe₂); tungsten disulfide (WS₂); tungsten diselenide (WSe₂); hexagonal boron nitride (h-BN); gallium sulfide (GaS); gallium selenide (GaSe); lanthanum cuprate (La₂CuO₄); bismuth tritelluride (Bi₂Te₃); bismuth triselenide (Bi₂Te₃); antimony triselenide (Sb₂Se₃); zinc oxide (ZnO); niobium disulfide (NbS₂); niobium diselenide (NbSe₂); tantalum disulfide (TaS₂); vanadium disulfide (VS₂); rhenium disulfide (ReS₂); rhenium diselenide (ReSe₂); titanium disulfide (TS₂); titanium diselenide (TSe₂); indium trisulfide (InS₃); zirconium disulfide (ZrS₂); zirconium diselenide (ZrS₂); or cadmium selenide (CdSe); and
from about 0.1 to about 50% by weight of the solid polymer dispersion of a plasticizer for the solid polymer dispersion media; and
(b) by using a three-dimensional (3D) printing technique, a fused deposition modeling (FDM) technique, or a selective laser sintering (SLS), forming the solid polymer dispersion of step (a) into an article comprising nanoplatelet graphene-like material substantially uniformly dispersed in a solid polymer.

32. The method of claim 31, wherein the solid polymer dispersion of step (a) is formed by melting the thermoplastic polymers.

33. The method of claim 31, wherein the article formed in step (b) comprises a printed circuit board, heat sink, ion battery, capacitor, antennae, electromagnetic interference shielding, electromagnetic radiation shields, solar cell grid collectors, or electrostatic shields.

34. The method of claim 31, wherein step (b) is carried out by a three-dimensional (3D) printing technique which comprises depositing layers of the solid polymer dispersion of step (a).

35. The method of claim 34, wherein step (b) is carried out by depositing the solid polymer dispersion of step (a) as a film on a substrate.

36. The method of claim 31, wherein the solid polymer of step (a) comprises one or more of: acrylate polymers; methyl methacrylate polymers; acrylate and methacrylate copolymers; polylactic acid (PLA) polymers; polyhydroxyalkanoate (PHA) polymers; polycaprolactone (PCL) polymers; polyglycolic acid polymers; acrylonitrile-butadiene-styrene (ABS) polymers; polyvinylidene fluoride polymers; polyurethane polymers; polyolefin polymers; polyester polymers; or polyamide polymers.

37. The method of claim 31, wherein step (b) is carried out by using a filament or pellet comprising the dispersed nanoplatelet graphene-like material solid polymer in a fused deposition modeling (FDM) technique.

37. The method of claim 31, wherein step (b) is carried out by using a powder comprising the dispersed nanoplatelet graphene-like material solid polymer in selective laser sintering (SLS) technique.
